(19) United States
(12) Patent Application Publication
(10) Pub. No.: US 2015/0062875 A1
(43) Pub. Date: Mar. 5, 2015

(54) Foaming Shoe with Built-In Luminous Component

(71) Applicant: John Gou, ShenZhen City (CN)

(72) Inventor: John Gou, ShenZhen City (CN)

(21) Appl. No.: 14/016,168

(22) Filed: Sep. 2, 2013

(51) Int. Cl. F21V 33/00

(52) U.S. Cl. CPC F21V 33/0008
USPC 362/103

(57) ABSTRACT

A foaming shoe with built-in luminous component can include a luminous component embedded in a shoe body. A groove may be arranged on the shoe body. A luminous embedment groove is arranged on the shoe body along any one or more parts, i.e. the vamp, the cylinder and the side edge of the bottom, the luminous component comprises a luminous controller and a plurality of luminous bodies electrically connected with the luminous controller via an electric wire, the luminous controller is embedded in the accommodating groove, the plurality of luminous bodies are embedded in the luminous embedment groove on the shoe body, a packaging cover is arranged, in a covering manner, on the bottom in correspondence to the accommodating groove, a light-permeable cover is arranged, in a covering manner, on the shoe body in correspondence to the luminous embedment groove, and the plurality of luminous bodies are connected.

### TECHNICAL FIELD

The invention relates to the field of footwear, in particular to a shoe with a built-in luminous component for shoe body decoration.

### BACKGROUND

As is well known to us all, shoes make children feel restrained on feet, so they like to take the shoes off, bare feet is unfavorable for children's personal cleanness and body health and further brings a negative impact on walk-learning interest of children, however, luminous shoes with flashing lights become quite popular among children and adults because of their fashionable, fancy luminous and flashing features, children who wear shoes emitting light in various colors feel extremely excited, as a result, these shoes have won great support of parents. In order to further enhance the walking interest of walk-learning children, various types of shoes with LED light sources embedded therein have been also designed, wherein a motion-driving switch is arranged in a drive circuit for the LED light source in general, motion of a shoe wearer triggers the motion-driving switch, which further triggers the drive circuit to control the LED luminous light bodies to achieve light emission.

In traditional shoes that are capable of emitting light, however, luminous bodies are attached on the vamp and the luminous controller is embedded in the thick heel on the shoe bottom, therefore, special treatments, like waterproof treatment, anti-impact treatment and anti-bending treatment, need to be carried out on the luminous bodies and the luminous controller embedded on the shoe as well as on the connection electric wire for connection between the luminous bodies and the luminous controller, moreover, these traditional shoes are complex in manufacturing, that is to say, the vamp and the bottom needs to be manufactured separately and the vamp is then mounted on the bottom, such a process creates a disadvantage in mounting the luminous bodies and in connecting the luminous bodies with the luminous controller via the electric wire, and also changes the original shoemaking process flow, consequently, the original complex shoemaking procedure becomes more difficult to comprehend.

### SUMMARY OF THE INVENTION

An objective of the invention is to provide a foaming shoe with built-in luminous component, and aims at solving the main technical problems that: the traditional process for luminous shoes is complex, furthermore, the waterproof, anti-impact and anti-bending properties of the luminous bodies, the luminous controller and the connection electric wire are poor due to the mounting condition of the shoes themselves.

This invention provides a foaming shoe with built-in luminous component, which comprises:

a shoe body, the shoe body being made of an EVA foaming material, an accommodating groove being arranged on the bottom of the shoe body, and a luminous embedment groove being arranged on the shoe body along any one or any two or all of the three parts, i.e. the vamp, the cylinder and the side edge of the bottom,

and a luminous component embedded in the shoe body, the luminous component comprising a luminous controller and a plurality of luminous bodies electrically connected with the luminous controller via an electric wire, the luminous controller being embedded in the accommodating groove, and the plurality of luminous bodies being embedded in the luminous embedment groove,

a packaging cover being arranged, in a covering manner, on the bottom in correspondence to the accommodating groove, and a light-permeable cover being arranged, in a covering manner, on the shoe body in correspondence to the luminous embedment groove,

the plurality of luminous bodies being connected in parallel in one group or multiple groups.

Preferred: a vibration switch is arranged in the luminous controller.

Preferred: the shoe body is integrally formed by the EVA foaming material, the accommodating groove is arranged on the bottom in correspondence to the center of foot sole, the luminous embedment groove on the shoe body is communicated with the accommodating groove, the luminous controller is arranged in the accommodating groove, the plurality of luminous bodies are all embedded in the luminous embedment groove, sealant is filled in both the accommodating groove and the luminous embedment groove, and the light-permeable cover and the packaging cover respectively cover the luminous embedment groove and the accommodating groove in a sealing manner.

Preferred: the light-permeable cover is a decorative strip made of a flexible light-permeable material, and the decorative strip is bonded on the luminous embedment groove in a sealing manner.

Preferred: the plurality of luminous bodies are all LED patch lamp beads, the plurality of LED patch lamp beads are connected to the electric wire in parallel, each of the LED patch lamp beads has an anode weld leg and a cathode weld leg, and the anode weld legs and the cathode weld legs of the plurality of LED patch lamp beads, which are connected to the same electric wire in parallel, are directly welded on the anode wire and the cathode wire of the electric wire, respectively.

Preferred: the shoe body comprises a bottom and a vamp, the bottom is made of an EVA foaming material, the vamp is made of a flexible light-permeable material, the luminous embedment groove is arranged at the side edge of the bottom, the plurality of luminous bodies are embedded in the luminous embedment groove, the light-permeable cover is a light-permeable prism, and the vamp is adhered to the side edge of the bottom.

Preferred: the shoe body is integrally formed by an EVA foaming material, the luminous controller is arranged in the accommodating groove, the luminous embedment groove is a plurality of holes distributed on the vamp, a liner is arranged in the shoe body, the luminous bodies and the holes are consistent in quantity, the plurality of luminous bodies are all fixed on the liner, and the plurality of luminous bodies are embedded in the plurality of holes in a one-to-one correspondence manner.

Preferred: the shoe body is a boot integrally formed by an EVA foaming material, the luminous embedment groove is arranged on the cylinder of the boot, and the luminous bodies are embedded in the luminous embedment groove on the cylinder.

Compared with the prior art, the invention has the beneficial effects that:

In specific implementation of the invention, the shoe is made of the EVA foaming material, and an accommodating groove and a luminous embedment groove for mounting the luminous controller and the luminous bodies are preformed on the shoe, thus the order of normal production process for shoe is not affected too much, in addition, sealant is used for packaging the luminous controller and the luminous bodies in the foaming shoe, which can enhance the anti-impact and anti-bending properties of the luminous bodies, the luminous controller and the connection electric wire effectively, and the luminous controller is embedded in the center of foot sole on the bottom of the shoe, this site, which is exactly the foot arch, is free of stress, so the comfort at the bottom of the shoe is not affected, and the problem in the traditional luminous shoes that the shoe root is hard and hurts the foot owing to mounting of the luminous controller at the heel site is solved.

### BRIEF DESCRIPTION OF THE DRAWINGS

FIG. 1 is a schematic diagram illustrating mounting of the luminous component of an integrally-formed shoe in the invention.

FIG. 2 is an exploded diagram of the product in FIG. 1 in the invention.

FIG. 3 is a schematic diagram illustrating parallel connection mode between the electric wire and the LED patch lamp beads in the invention.

FIG. 4 is an exploded schematic diagram of a shoe with two parts formed separately, i.e. bottom and vamp, in the invention.

FIG. 5 is an exploded schematic diagram of a shoe having the liner in the invention.

FIG. 6 is a schematic diagram of a luminous component-mounted boot in the invention.

### DETAILED DESCRIPTION OF THE PREFERRED EMBODIMENTS

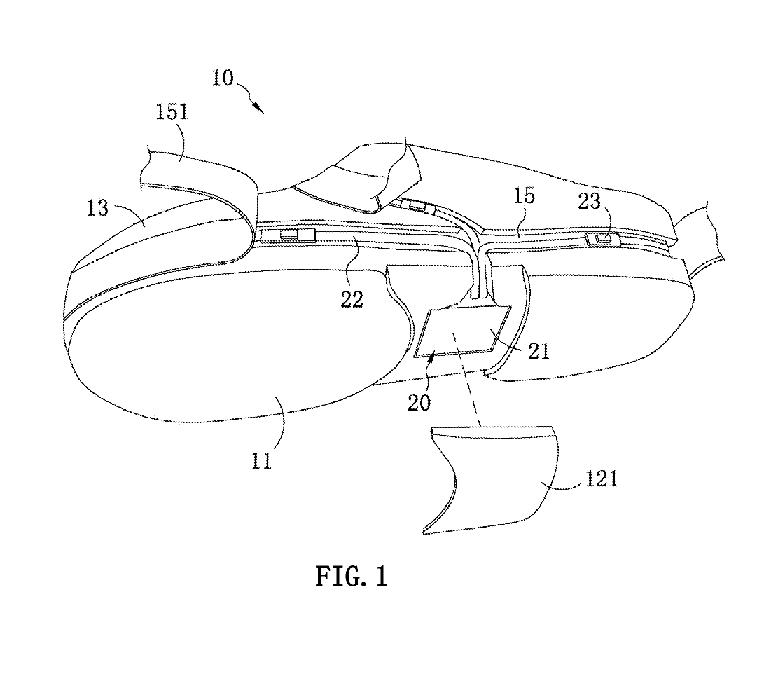

With reference to FIG. 1 to FIG. 6 and the preferred embodiments, detailed description will be made below to the foaming shoe with built-in luminous component disclosed in the invention.

As shown in FIG. 1 to FIG. 6, provided in the invention is a foaming shoe with built-in luminous component, the foaming shoe comprises a shoe body 10 and a luminous component 20 embedded in the shoe body, the shoe body 10 is made of an EVA foaming material, an accommodating groove 12 is arranged on the bottom 11 of the shoe body 10, a luminous embedment groove 15 is arranged on the shoe body 10 along any one or any two or all of the three parts, i.e. the vamp 13, the cylinder 14 and the side edge of the bottom 11, the luminous component 20 comprises a luminous controller 21 and a plurality of luminous bodies 23 electrically connected with the luminous controller 21 via an electric wire 22, the luminous controller 21 is embedded in the accommodating groove 12, and the plurality of luminous bodies 23 are embedded in the luminous embedment groove 15 on the shoe body 20, a packaging cover 121 is arranged, in a covering manner, on the bottom 11 in correspondence to the accommodating groove 12, a light-permeable cover 151 is arranged, in a covering manner, on the shoe body 10 in correspondence to the luminous embedment groove 15, and the plurality of luminous bodies 23 are connected in parallel in one group or multiple groups.

Preferred embodiment: a vibration switch is arranged in the luminous controller 21.

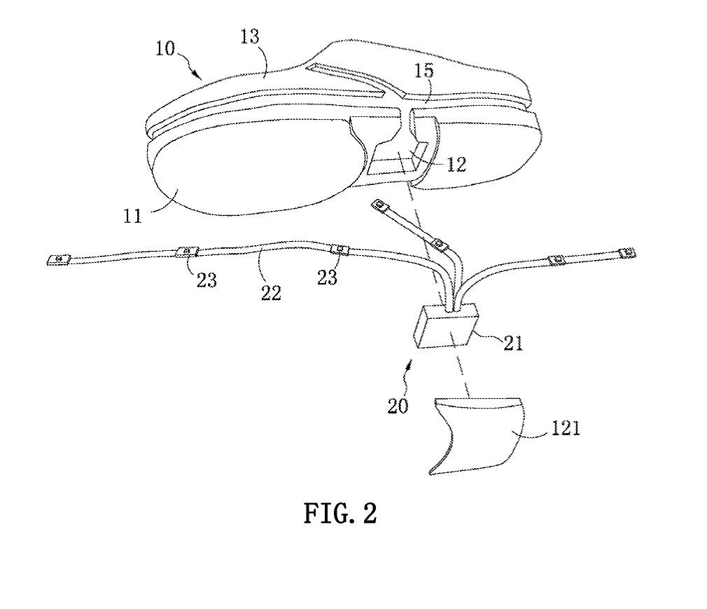

Preferred embodiment: as shown in FIG. 1 and FIG. 2, the shoe body 10 is integrally formed by the EVA foaming material, the accommodating groove 12 is arranged on the bottom 11 in correspondence to the center of foot sole, the luminous embedment groove 15 on the shoe body 10 is communicated with the accommodating groove 12, the luminous controller 21 is arranged in the accommodating groove 12, the plurality of luminous bodies 23 are all embedded in the luminous embedment groove 15, sealant is filled in both the accommodating groove 12 and the luminous embedment groove 15, and the light-permeable cover 151 and the packaging cover 121 respectively cover the luminous embedment groove 15 and the accommodating groove 12 in a sealing manner.

Preferred embodiment: as shown in FIG. 1, the light-permeable cover 151 is a decorative strip made of a flexible light-permeable material, and the decorative strip is bonded on the luminous embedment groove 15 in a sealing manner.

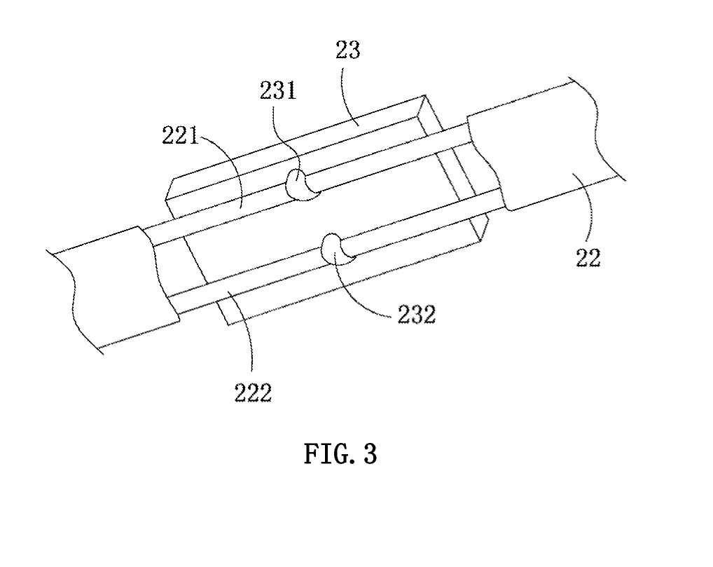

Preferred embodiment: as shown in FIG. 3, the plurality of luminous bodies 23 are all LED patch lamp beads, the plurality of LED patch lamp beads are connected to the electric wire 22 in parallel, each of the LED patch lamp beads has an anode weld leg 231 and a cathode weld leg 232, and the anode weld legs 231 and the cathode weld legs 232 of the plurality of LED patch lamp beads, which are connected to the same electric wire 22 in parallel, are directly welded on the anode wire 221 and the cathode wire 222 of the electric wire 22, respectively. In this way, the plurality of LED patch lamp beads can be connected to the electric wire 22 in parallel without cutting off the electric wire 22, direct welding can be accomplished only by striping off a section of the electric wire 22 to expose the anode wire 221 and the cathode wire 222 therein, so the electric wire 22 will not be damaged while the efficiency of welding the LED patch lamp beads in parallel is improved, and the overall tensile strength and anti-bending property of the whole group of parallelly-connected LEDs is enhanced.

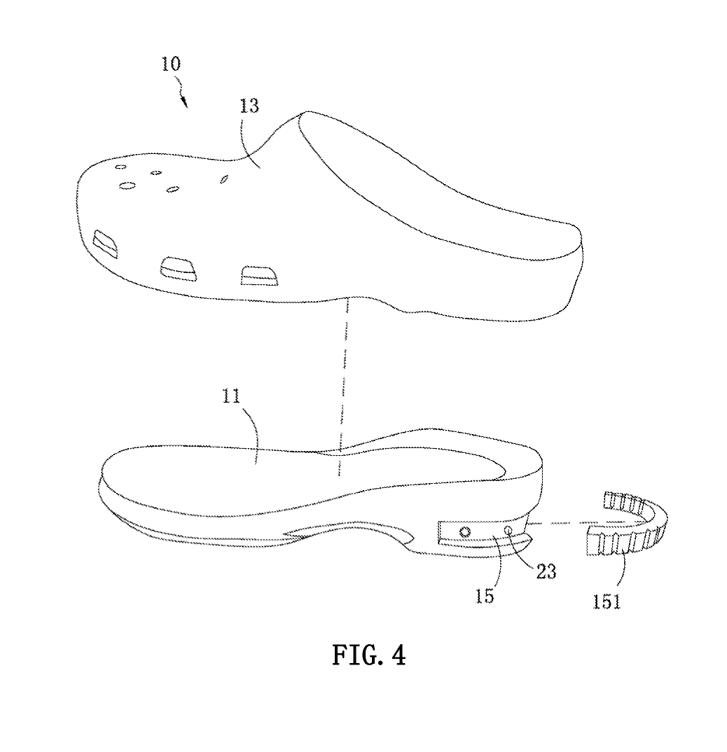

Preferred embodiment: as shown in FIG. 4, the shoe body 10 comprises a bottom 11 and a vamp 13, the bottom 11 is made of an EVA foaming material, the vamp 13 is made of a flexible light-permeable material, the luminous embedment groove 15 is arranged at the side edge of the bottom 11, the plurality of luminous bodies 23 are embedded in the luminous embedment groove 15, the light-permeable cover 151 is a light-permeable prism, and the vamp 13 is adhered to the side edge of the bottom 11.

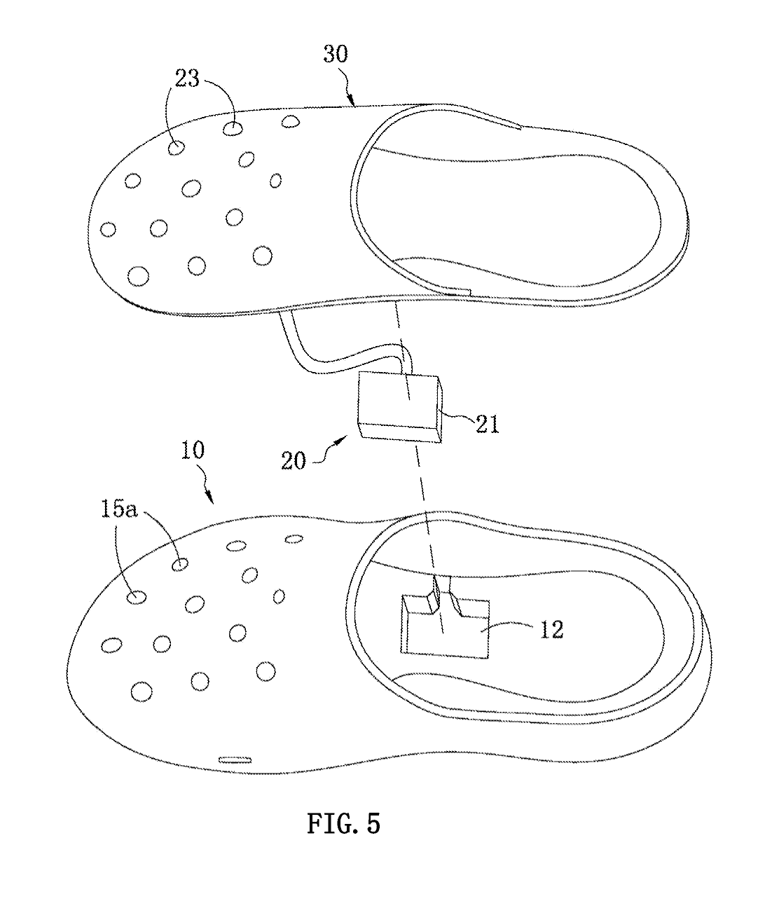

Preferred embodiment: as shown in FIG. 5, the shoe body 10 is integrally formed by an EVA foaming material, the luminous controller 21 is arranged in the accommodating groove 12, the luminous embedment groove 15 is a plurality of holes 15a distributed on the vamp 13, a liner 30 is arranged in the shoe body 10, the luminous bodies 23 and the holes 15a are consistent in quantity, the plurality of luminous bodies 23 are all fixed on the liner 30, and the plurality of luminous bodies 23 are embedded in the plurality of holes 15a in a one-to-one correspondence manner.

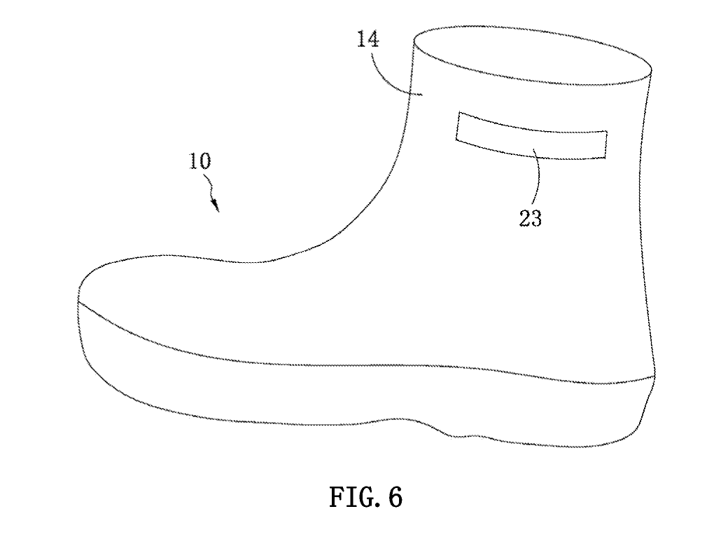

Preferred embodiment: as shown in FIG. 6, the shoe body 10 is a boot integrally formed by an EVA foaming material, the luminous embedment groove 15 is arranged on the cylinder 14 of the boot, and the luminous bodies 23 are embedded in the luminous embedment groove 15 on the cylinder 14.

All the substitution contents within the scope mentioned in patent claims are included in the invention. Any equivalent variation made within the patent claims of the invention shall fall within the patent scope of this application.

What is claimed is:

1. A foaming shoe with built-in luminous component, characterized in that the foaming shoe comprises:
a shoe body, the shoe body being made of an EVA foaming material, an accommodating groove being arranged on the bottom of the shoe body, and a luminous embedment groove being arranged on the shoe body along any one or any two or all of the three parts, i.e. the vamp, the cylinder and the side edge of the bottom,
and a luminous component embedded in the shoe body, the luminous component comprising a luminous controller and a plurality of luminous bodies electrically connected with the luminous controller via an electric wire, the luminous controller being embedded in the accommodating groove, and the plurality of luminous bodies being embedded in the luminous embedment groove,
a packaging cover being arranged, in a covering manner, on the bottom in correspondence to the accommodating groove, and a light-permeable cover being arranged, in a covering manner, on the shoe body in correspondence to the luminous embedment groove,
the plurality of luminous bodies being connected in parallel in one group or multiple groups.

2. The foaming shoe with built-in luminous component according to claim 1, characterized in that: a vibration switch is arranged in the luminous controller.

3. The foaming shoe with built-in luminous component according to claim 2, characterized in that: the shoe body is integrally formed by the EVA foaming material, the accommodating groove is arranged on the bottom in correspondence to the center of foot sole, the luminous embedment groove on the shoe body is communicated with the accommodating groove, the luminous controller is arranged in the accommodating groove, the plurality of luminous bodies are all embedded in the luminous embedment groove, sealant is filled in both the accommodating groove and the luminous embedment groove, and the light-permeable cover and the packaging cover respectively cover the luminous embedment groove and the accommodating groove in a sealing manner.

4. The foaming shoe with built-in luminous component according to claim 3, characterized in that: the light-permeable cover is a decorative strip made of a flexible light-permeable material, and the decorative strip is bonded on the luminous embedment groove in a sealing manner.

5. The foaming shoe with built-in luminous component according to claim 4, characterized in that: the plurality of luminous bodies are all LED patch lamp beads, the plurality of LED patch lamp beads are connected to the electric wire in parallel, each of the LED patch lamp beads has an anode weld leg and a cathode weld leg, and the anode weld legs and the cathode weld legs of the plurality of LED patch lamp beads, which are connected to the same electric wire in parallel, are directly welded on the anode wire and the cathode wire of the electric wire, respectively.

6. The foaming shoe with built-in luminous component according to claim 2, characterized in that: the shoe body comprises a bottom and a vamp, the bottom is made of an EVA foaming material, the vamp is made of a flexible light-permeable material, the luminous embedment groove is arranged at the side edge of the bottom, the plurality of luminous bodies are embedded in the luminous embedment groove, the light-permeable cover is a light-permeable prism, and the vamp is adhered to the side edge of the bottom.

7. The foaming shoe with built-in luminous component according to claim 2, characterized in that: the shoe body is integrally formed by an EVA foaming material, the luminous controller is arranged in the accommodating groove, the luminous embedment groove is a plurality of holes distributed on the vamp, a liner is arranged in the shoe body, the luminous bodies and the holes are consistent in quantity, the plurality of luminous bodies are all fixed on the liner, and the plurality of luminous bodies are embedded in the plurality of holes in a one-to-one correspondence manner.

8. The foaming shoe with built-in luminous component according to claim 2, characterized in that: the shoe body is a boot integrally formed by an EVA foaming material, the luminous embedment groove is arranged on the cylinder of the boot, and the luminous bodies are embedded in the luminous embedment groove on the cylinder.
